(19) United States
(12) Patent Application Publication
(10) Pub. No.: US 2004/0252733 A1
(43) Pub. Date: Dec. 16, 2004

(54) Apparatus and method for laser frequency doubler utilizing PPLN waveguide

(76) Inventor: Zhenguo Huang, Fremont, CA (US)

Correspondence Address: HUANG, ZHENGUO, 42642 FERN. CIR., FREMONT, CA, 94538, US

(21) Appl. No.: 10/462,276

(22) Filed: Jun. 16, 2003

(51) Int. Cl. H01S 3/10

(52) U.S. Cl. 372/22

(57) ABSTRACT

An apparatus and a method for frequency doubling of a fiber coupled diode laser that provides substantially enhanced power output in the visible region, is disclosed. This apparatus and method can be used in many applications in areas such as display, bio- and medical-instrumentation. A key step of the method is to couple a diode laser with a waveguide of periodically poled lithium niobate (PPLN) through a polarization maintaining fiber and a Fiber Bragg Grating (FBG) that is coupled to the laser diode and serves as the end mirror of the laser cavity.

### BACKGROUND OF THE INVENTION

1. Field of the Invention

The present invention relates generally to the field of laser instrumentation and more particularly to the fabrication of a frequency doubled, fiber coupled diode laser.

2. Background Art

In the past several decades, scientists and engineers are searching for improved laser sources, with a particular interest placed in the blue region of the visible spectrum. A compact and high intensity blue laser can be used in many applications from digital information storage, color display and printing, and in medical and biological instrumentation. The most relevant patents to this invention appear to be U.S. Pat. No. 6,282,016 to MacCormack et al and U.S. Pat. No. 5,185,752 to Welch and Waarts. These patents are thereby included herein by ways of reference.

A typical prior art blue laser is illustrated in FIG. 1. The laser consists of a laser diode 110, a frequency doubling PPLN waveguide 150, a coupling element 135, e.g., a focus lens. Typically, the laser diode has its back surface coated with a highly reflective coating 120, and the front surface of the diode 130 is coated partially reflective (PR) coating. The PR coating serves as an output coupler for the diode laser. The frequency-doubling unit is a PPLN waveguide 150, with a typical cross section of few micron meters by few micron meters, surrounded by lower index substrate 140. The entrance surface adjacent to the diode normally is coated with anti-reflective coatings for the fundamental wavelength whereas the exit surface is typically coated with anti-reflective coatings for the frequency doubled light beam. The light-coupling element 160, normally converts the divergent light into a collimated output 170. In certain applications, the coupling element 160 is an optical fiber, with a tapped end that serves as collimating optics.

Another typical prior art related to the present invention is a fiber coupled diode laser device depicted in FIG. 2. The fiber coupled diode laser device consists of a diode gain region 210, a light-coupling element 235, and a polarization maintaining fiber 240 with a section of Bragg Grating reflector 245. Typically, the diode gain region has a high reflective coating 220, and an anti-reflective coating 230. The light-coupling element 235 may consists of a non-spherical lens or a tapered fiber end that provides efficient coupling to the fiber. The optical surfaces of the coupling element are normally coated for anti-reflective coatings to reduce loss. The FBG reflector is designed to reflect only in a narrower frequency range. It is within this range, that laser amplification is observed.

These prior art approaches have several areas for improvements. For example, the blue laser illustrated in FIG. 1 has many longitudinal cavity modes and a broadband spectrum that make output not uniform and unstable because of the interfering of these modes. More importantly, the light conversion efficiency is not high enough due to the spectra mismatch of the laser diode (spectra width 5 nm) and that of the PPLN (spectrum window for doubling is very narrow and −0.2 nm). For prior art illustrated in FIG. 2, the output wavelength is typically in the red and IR region of the spectrum. There is a need therefore to have improvements to these prior arts such that a high intensity frequency doubled blue laser source can be realized.

### SUMMARY OF THE INVENTION

The present invention discloses an improved apparatus and a method for frequency doubling of a fiber coupled diode laser that provides substantially enhanced efficiency and power output in the visible region. This apparatus and method can be used in many applications in areas such as display, bio- and medical-instrumentation. A key step of the method is to couple a diode laser with a waveguide of periodically poled material such as lithium niobate (PPLN) through a polarization maintaining fiber and a Fiber Bragg Grating (FBG) that is coupled to the laser diode and serves as the end mirror of the laser cavity.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows the structure of a prior art frequency doubled diode laser;

FIG. 2 illustrates the structure of a prior art fiber coupled diode laser consisting of a diode gain region, a coupling unit, a fiber, and a FBG reflector;

FIG. 3 displays an improved frequency doubling fiber-coupled diode laser consisting of diode gain region, a PM fiber, FBG reflector, PPLN wave-guide, and optical coupling elements;

FIG. 4 illustrates another improved frequency doubling fiber-coupled diode laser consisting of diode gain region, a PM fiber, FBG reflector, PPLN wave-guide, and optical coupling elements.

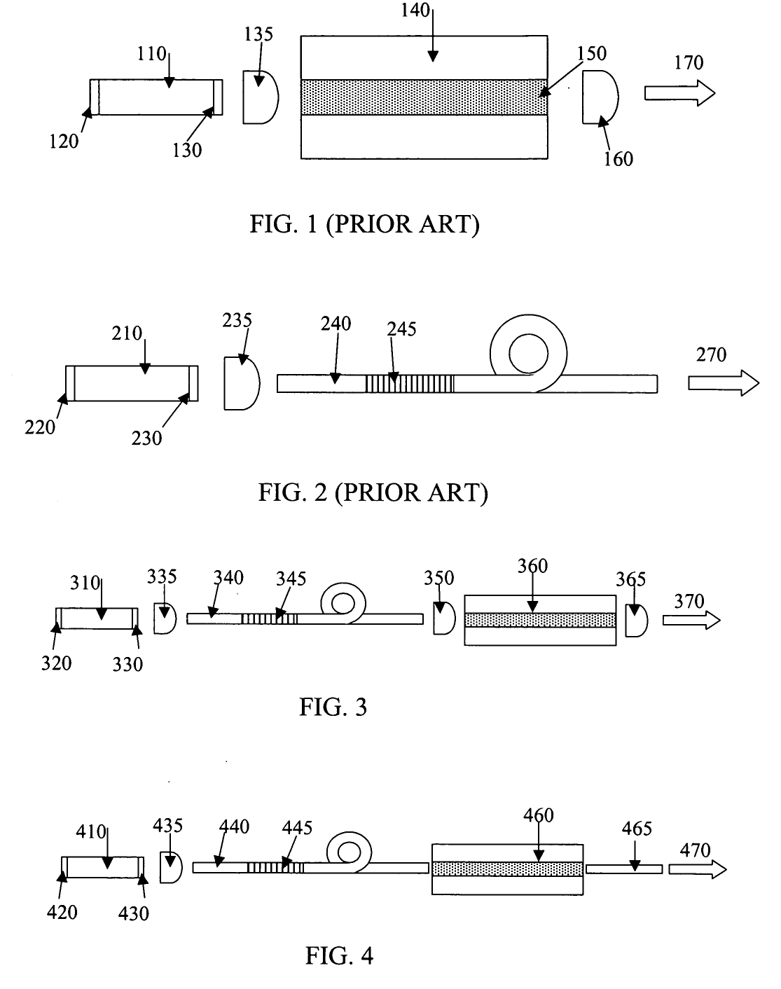

### DETAILED DESCRIPTION OF THE INVENTION

The present invention discloses a new method and apparatus to obtain frequency-doubled output of a fiber-coupled diode laser device. The new method departs from the prior art practice of directly doubling of the diode laser output. The basic concept is to introduce a polarization maintaining fiber and a Fiber Bragg Grating (FBG) reflector in between the laser diode and the PPLN waveguide. The new approach provides a better match of the spectra widths of the fundamental and the frequency response window of the PPLN waveguide. The improved spectra match led a much better doubling efficiency.

The first preferred embodiment of the present invention is illustrated in FIG. 3. A laser diode gain region 310 consists of a laser diode with a highly reflective coating 320 and an anti-reflective coating 330. A polarization maintaining (PM) fiber 340 and a Fiber Bragg Grating (FBG) reflector 345 serves as an output coupler of the laser. A coupling element 335 serves to reduce the coupling loss between the laser diode and the fiber. The frequency doubling is achieved in the PPLN wave-guide 360. Another coupling element 350 provides efficient coupling between the PM fiber and the PPLN wave-guide. A third coupling element 365 provides a collimated output beam. In order to reduce intensity losses, the optical surfaces of the coupling elements are preferably coated with anti reflective coatings. Preferably, the optical surfaces of the PPLN wave-guide substrate 360 are coated for anti-reflective coatings to reduce reflective losses.

The second preferred embodiment of the present invention is illustrated in FIG. 4. A laser diode gain region 410 consists of a laser diode with a highly reflective coating 420 and an anti-reflective coating 430. A polarization maintaining fiber 440 and a FBG reflector 445 serves as an output coupler of the laser. A coupling element 435 serves to reduce the coupling loss between the laser diode and the fiber. The frequency doubling is achieved in the PPLN wave-guide 460. The fiber and PPLN wave-guide are directly aligned to within sub micrometers that provides efficient coupling. The output from the PPLN wave-guide is preferably coupled to the output fiber. The output-fiber and PPLN wave-guide are aligned to within sub micrometers that provides efficient coupling. In order to reduce intensity losses, preferably, the optical surfaces of the PPLN wave-guide substrate 460 are coated for anti-reflective coatings to reduce reflective losses. The surfaces are preferably wedged and have approximately 6-10 degree wedge angles.

It will be apparent to those with ordinary skill of the art that many variations and modifications can be made to the frequency doubling laser devices and the method of making these devices disclosed herein without departing form the spirit and scope of the present invention. It is therefore intended that the present invention cover the modifications and variations of this invention provided that they come within the scope of the appended claims and their equivalents, what is claimed is:

1. An frequency doubled laser device comprising:
a diode gain region;
a periodically poled frequency doubling waveguide;
a polarization maintaining fiber and FBG reflector being placed between the said diode gain region and the said doubling wave-guide;
and a coupling element being placed between the said diode gain region and the said fiber based FBG reflector.

2. The frequency doubled laser device recited in claim 1 wherein the said diode gain region further consists of a highly reflective and partially reflective coating.

3. The frequency doubled laser device recited in claim 1 wherein the said diode gain region having light emission in the wavelength region of 635 nm to 1600 nm.

4. The frequency doubled laser device recited in claim 1 wherein the said periodically poled frequency-doubling waveguide being fabricated with the following non-linear laser material: LiNbO₃, KTP, LBO.

5. The frequency doubled laser device recited in claim 1 wherein the said periodically poled frequency-doubling waveguide being able to yield second harmonic output in the wavelength region of 317.5 nm to 800 nm.

6. The frequency doubled laser device recited in claim 1 wherein the said FBG reflector having reflectivity in a given wavelength range of 0.1 nm to 0.2 nm.

7. The frequency doubled laser device recited in claim 1 wherein the said FBG reflector having reflectivity in the range of 5% to 20% in a given wavelength range.

8. The frequency doubled laser device recited in claim 1 wherein the said FBG reflector being fabricated using a polarization maintaining fiber.

9. The frequency doubled laser device recited in claim 1 wherein the said diode gain region being maintained at a pre-determined temperature.

10. The frequency doubled laser device recited in claim 1 wherein the said periodically poled frequency-doubling waveguide being maintained at a pre-determined temperature.

11. A method for assembling an frequency doubled laser device comprising:
fixing diode gain region to the laser housing;
aligning and fixing the position of coupling element with respect to the position of the diode gain region;
aligning and fixing the position of PM fiber with respect to the position of the coupling element;
aligning and fixing the position of a periodically poled frequency doubling waveguide with respect to the position of the PM fiber;

12. The method recited in claim 11 wherein the said diode gain region further consists of a highly reflective and partially reflective coating.

13. The method recited in claim 11 wherein the said diode gain region having light emission in the wavelength region of 635 nm to 1600 nm.

14. The method recited in claim 11 wherein the said the said periodically poled frequency-doubling wave-guide being fabricated with the following non-linear laser material: KTP, LiNbO3, LBO.

15. The method recited in claim 11 wherein the said periodically poled frequency-doubling wave-guide being able to yield second harmonic output in the wavelength region of 317.5 nm to 800 nm.

16. The method recited in claim 11 wherein the said FBG reflector having reflectivity in the range of 5% to 20% in a given wavelength range of 0.1 to 0.2 nm.

17. The method recited in claim 11 wherein the said FBG reflector being fabricated using a polarization maintaining fiber.

18. The method recited in claim 11 wherein the said coupling element being a lens that efficiently couples said light from said diode gain region to the said PM fiber based.

19. The method recited in claim 15 wherein the said diode gain region being maintained at a pre-determined temperature.

20. The method recited in claim 15 wherein the said periodically poled frequency-doubling waveguide being maintained at a pre-determined temperature.
